(19) United States
(12) Patent Application Publication
(10) Pub. No.: US 2011/0157559 A1
(43) Pub. Date: Jun. 30, 2011

(54) Visual display apparatus

(76) Inventor: Takayoshi Togino, Koganei-shi (JP)

(21) Appl. No.: 12/806,469

(22) Filed: Aug. 13, 2010

(30) Foreign Application Priority Data
Aug. 20, 2009 (JP) 2009-190782

(51) Int. Cl. G03B 21/28

(52) U.S. Cl. 353/38

(57) ABSTRACT

The invention provides a visual display apparatus 1 comprising an image display device 3, a projection optical system 4 adapted to provide an image on the image display device 3, and an eyepiece optical system 5 adapted to allow an image projected through the projection optical system 4 to be viewed as a faraway virtual image. The eyepiece optical system 5 comprises a diffusing surface 11 adapted to diffuse an image projected through the projection optical system 4, a reflective optical device 51 having at least one reflecting surface adapted to reflect an image diffused through the diffusing surface 11, and at least one rotationally asymmetric transmissive optical device 52 adapted to transmit an image reflected by the reflective optical device 52. The number of imaging differs at a certain first section, and at a second section orthogonal to the first section.

### BACKGROUND OF THE INVENTION

The present invention relates generally to a visual display apparatus, and more particularly to a visual display apparatus capable of displaying an image over a wide range of angles of view.

Such an arrangement as set forth in JP(A) 10-206790 has been known so far for viewing virtual images.

### SUMMARY OF THE INVENTION

The present invention provides a visual display apparatus comprising an image display device, a projection optical system to project an image on said image display device, and an eyepiece optical system to enable an image projected through said projection optical system to be viewed as a faraway virtual image, wherein said eyepiece optical system includes a diffusing surface to diffuse an image projected through said projection optical system, a reflective optical device having at least one reflecting surface to reflect an image diffused through said diffusing surface, and at least one rotationally asymmetric transmissive optical device to transmit an image reflected by said reflective optical device, preferably with the number of imaging (image formation) differing at a certain first section and at a second section orthogonal to said first section.

Preferably, the aforesaid number of imaging is 0 at the aforesaid first section and one at the aforesaid second section.

Preferably, the aforesaid reflective optical device, and the aforesaid transmissive optical device has a refractive index higher at the aforesaid second section than at the aforesaid first section.

Preferably, the aforesaid reflective optical device is rotationally symmetric about an axis of rotational symmetry.

The aforesaid second section include the aforesaid axis of rotational symmetry.

Preferably, the aforesaid eyepiece optical system has a visual axis including a center chief ray traveling from the center of an entrance pupil toward the aforesaid reflective optical device via the aforesaid transmissive optical device upon back ray tracing in the aforesaid second section, and the aforesaid reflective optical device is decentered with respect to the aforesaid visual axis in the aforesaid second section.

Preferably, the aforesaid visual axis and the aforesaid axis of rotational symmetry are orthogonal to each other.

Preferably, the aforesaid diffusing surface is rotationally symmetric about the aforesaid axis of rotational symmetry.

Preferably, the aforesaid reflective optical device has a cylindrical form of linear Fresnel reflecting surface.

Preferably, the shape of the aforesaid reflective optical device on one side with respect to the aforesaid visual axis is different from that on another side in the aforesaid second section.

Preferably, the shape of the aforesaid transmissive optical device on one side with respect to the aforesaid visual axis is different from that on another side in the aforesaid second section.

Preferably, the aforesaid transmissive optical device comprises a first Y-toroidal surface having a first axis of planar and rotational symmetry, which is the center of rotation, in a surface of the aforesaid reflective optical device including the aforesaid axis of rotational symmetry, and a second Y-toroidal surface having a second axis of planar and rotational symmetry, which is different from the aforesaid first axis of planar and rotational symmetry.

Preferably, the aforesaid transmissive optical device comprises a free-form surface.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is conceptually illustrative of a visual display apparatus.

FIG. 2 is a plan view of FIG. 1.

FIG. 3 is illustrative of a visual display apparatus used in combination with a seat.

FIG. 4 is illustrative of a coordinate system for an embodiment of the visual display apparatus.

FIG. 5 is a sectional view of the visual display apparatus according to inventive Example 1 as taken along its axis of rotational symmetry.

FIG. 6 is a plan view of FIG. 5.

FIG. 7 is a transverse aberration diagram for the whole optical system of Example 1.

FIG. 8 is a transverse aberration diagram for the whole optical system of Example 1.

FIG. 9 is indicative of image distortion on the diffusing surface (image plane) while being viewed by the left eye, upon back ray tracing in Example 1.

FIG. 10 is a sectional view of the visual display apparatus according to inventive Example 2 as taken along its axis of rotational symmetry.

FIG. 11 is a plan view of FIG. 10.

FIG. 12 is a transverse aberration diagram for the whole optical system of Example 2.

FIG. 13 is a transverse aberration diagram for the whole optical system of Example 2.

FIG. 14 is indicative of image distortion on the diffusing surface (image plane) while being viewed by the left eye, upon back ray tracing in Example 2.

FIG. 15 is a sectional view of the visual display apparatus according to inventive Example 3 as taken along its axis of rotational symmetry.

FIG. 16 is a plan view of FIG. 15.

FIG. 17 is a transverse aberration diagram for the whole optical system of Example 3.

FIG. 18 is a transverse aberration diagram for the whole optical system of Example 3.

FIG. 19 is indicative of image distortion on the diffusing surface (image plane) while being viewed by the left eye, upon back ray tracing in Example 3.

FIG. 20 is illustrative of a pupil relay optical device located in the vicinity of an image projected through the visual display apparatus.

FIG. 21 is a plan view of FIG. 20.

### DESCRIPTION OF EXEMPLARY EMBODIMENTS

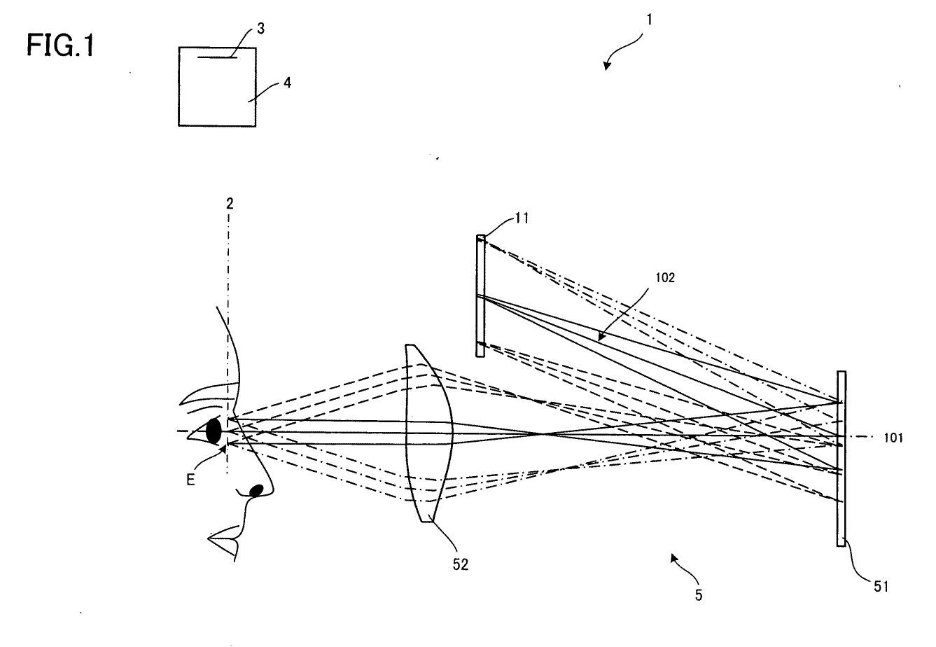

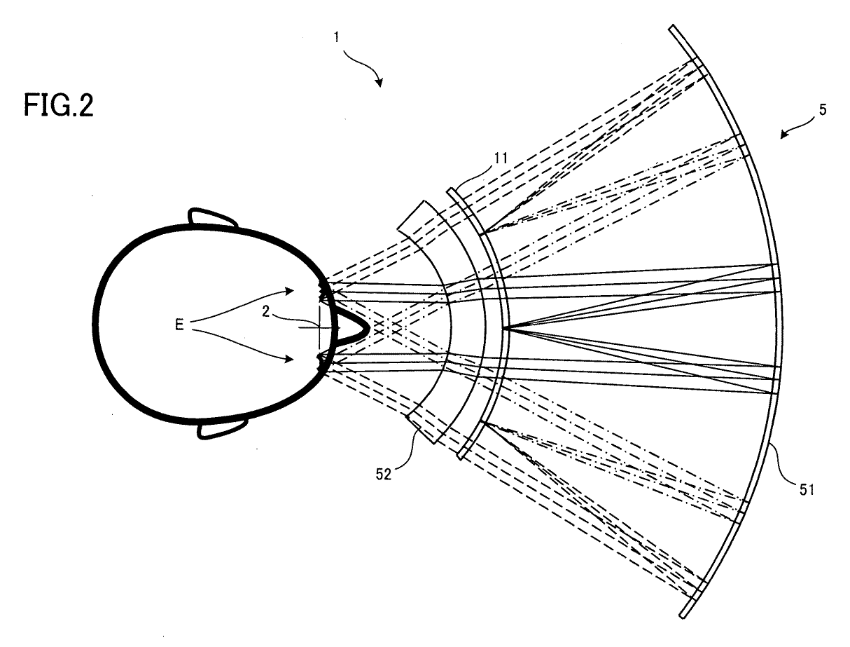

The visual display apparatus of the invention is now explained with reference to some examples. FIG. 1 is conceptually illustrative of a visual display apparatus 1, and FIG. 2 is a plan view of FIG. 1.

As shown in FIGS. 1 and 2, the visual display apparatus 1 is made up of an image display device 3, a projection optical system 4 adapted to project an image on the image display device 3, and an eyepiece optical system 5 adapted to allow an image projected through the projection optical system 4 to be viewed as a faraway virtual image. The eyepiece optical system 5 comprises a diffusing surface 11 adapted to diffuse an image projected through the projection optical system 4, a reflective optical device 51 having at least one reflecting surface adapted to reflect an image diffused by the projection optical system 4, and at least one rotationally asymmetric, transmissive optical device 52 adapted to transmit an image reflected by the reflective optical device 51, with the number of imaging (image formation) differing at a certain first section and at a second section orthogonal to the first section.

Generally, as the observation angle of view grows wide with increasing eye relief, the observation apparatus gets complicated. This is the reason the optical path taken is bent; however, it is still impossible to set a wide observation angle of view because of optical path interferences. On the other hand, as a diffusing surface is used to relieve loads on the projection optical system while the diameters of beams through the projection optical system are kept small, it causes the diffusing surface to interfere with the beams, rendering it impossible to make sure of a wide observation angle of view.

The embodiment here is designed such that the number of imaging (image formation) in the eyepiece optical system 5 differs at a certain first section and at a second section orthogonal to the first section, thereby bundling up the optical path involved to successfully stave off the optical path interference problem. With this arrangement, it is also possible to view an image having a horizontal angle of 50° or greater. Furthermore, because the image is relayed once in one single section alone, there is no interference between a viewing optical path and the diffusing surface 11 or the head of a viewer, etc. and light beams so that wide-angle images can be viewed.

The transmissive optical device 52 has action on correction of image distortions occurring at optical paths for both eyes, thereby correcting a planar or cylindrical image under view for swelling or tilting that occurs from vergence.

It is preferable that the number of imaging is 0 at the first section and one at the second section, because the decentered optical path is minimized, thereby achieving a visual display apparatus of smaller size.

It is preferable that the reflective optical device 51, and the transmissive optical device 52 has a refractive index stronger at the second section than at the first section. By bringing sectional directions of stronger power into alignment, it is possible to form an intermediate image that is to be formed halfway between the reflective optical device 51 and the transmissive optical device 52 in one single direction alone, thereby enabling the diameter of the light beam to be decreased.

It is preferable that the reflective optical device 51 is rotationally symmetric about the axis 2 of rotational symmetry. This in turn makes it possible to provide the eyepiece optical system 5 with much more improved productivity and at much lower costs.

For the second section it is preferable to include the axis 2 of rotational symmetry. It is then important that at the second section having the axis 2 of rotational symmetry, one imaging takes place in the eyepiece optical system 5, and at the first section orthogonal to the axis 2 of rotational symmetry there is no imaging occurring. Because there is none of light beam interferences in the first section orthogonal to the axis 2 of rotational symmetry, increasing the number of imaging in the first section is not preferable for correction of aberrations. In the second section having the axis 2 of rotational symmetry, on the other hand, it is important that one imaging takes place, because the angle of view growing wide causes optical path interferences. In the second section, it is possible to give power to the surface relatively freely, and it is easy to correct aberrations even with one imaging.

It is preferable that the eyepiece optical system 5 has a visual axis 101 including a center chief ray traveling from the center of an entrance pupil toward the reflective optical device 51 via the transmissive optical device 52 upon back ray tracing in the second section, and the reflective optical device 51 is decentered with respect to the visual axis 101 in the second section. In the section having the axis 2 of rotational symmetry, it is possible to determine surface shape freely, and it is possible to decenter the surface in the first section, thereby correcting decentration aberrations occurring at any surface due to decentration.

It is preferable that the visual axis 101 and the axis 2 of rotational symmetry are orthogonal to each other. By locating the axis 2 of rotational symmetry in a direction defining the direction vertical to the head of a viewer, it is possible to view an image that extends in the horizontal direction. This permits the reflective optical device 51 to have a rotationally symmetric surface extending in the horizontal direction, preferable for making the horizontal angle of view wide. This is also true for the human s visual sense that grows wider in the horizontal direction than in the vertical direction.

It is preferable that the diffusing surface 11 is rotationally symmetric about the axis 2 of rotational symmetry. This facilitates fabrication of the diffusing surface 11.

It is preferable that the reflective optical device 51 has a cylindrical form of linear Fresnel reflecting surface. If a linear Fresnel lens is processed into a reflecting surface and then bent into a cylindrical form, it is then possible to obtain the reflecting surface at lower costs.

It is preferable that in the second section, the shape of the reflecting optical device 51 on one side with respect to the visual axis 101 is different from that on another side. A reflecting surface 51b is decentered, producing decentration aberrations. It is then preferable that the decentration aberrations are corrected by transforming the reflective optical device 51 in the vertical direction to the center ray.

It is preferable that in the second section, the shape of the transmissive optical device 52 on one side with respect to the visual axis 101 is different from that on another side. It is then possible to correct field tilt in the second section and, hence, view a clear image. This also enables the diffusing surface 11 to be processed into a cylindrical form, resulting in productivity improvements.

It is preferable that the transmissive optical device 52 comprises a first Y-toroidal surface having a first axis 21 of planar and rotational symmetry that is the center of rotation in a surface including the axis 2 of rotational symmetry of the reflective optical device 51, and a second Y-toroidal surface having a second axis 22 of planar and rotational symmetry that is different from the first axis 21 of planar and rotational symmetry. This enables aberrations to be much more reduced.

It is preferable that the transmissive optical device 52 comprises a free-form surface that enables aberrations to remain minimized.

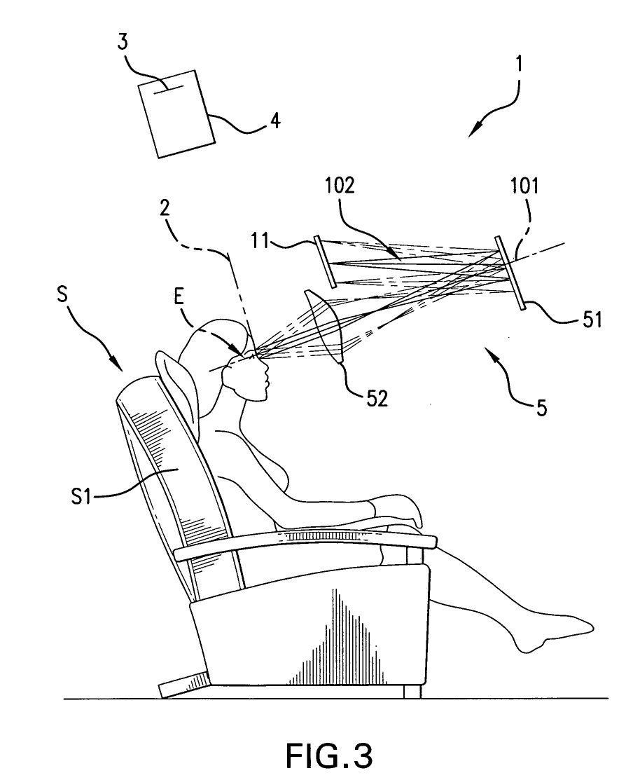

FIG. 3 is illustrative of the visual display apparatus 1 applied in combination with a seat S. The seat S here may be exemplified by a sofa or vehicle seat to which the visual display apparatus 1 is integrally coupled. Therefore, when the seat S has a built-in reclining function, the visual display apparatus 1 will have its angle adjustable depending on the angle of reclining of its back part S1.

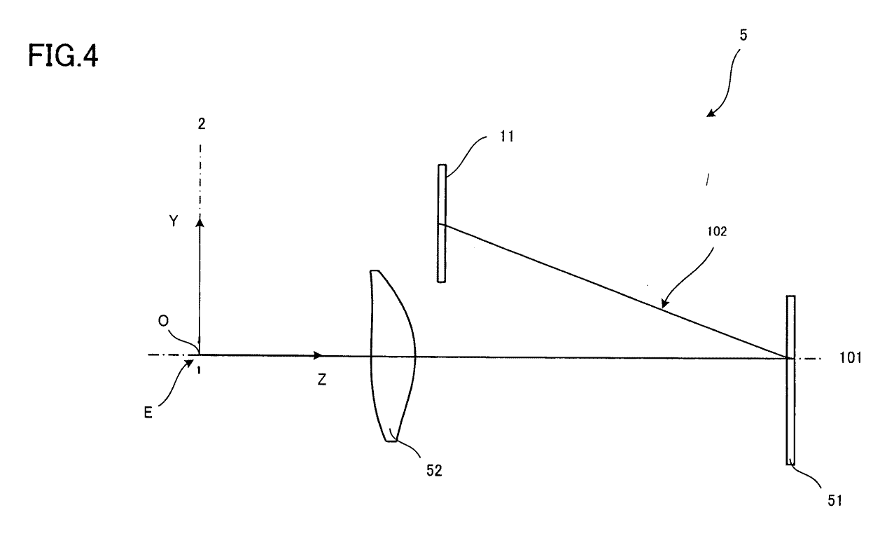

The optical system of the inventive visual display apparatus 1 is now explained with reference to some examples. The parameters constituting part of each optical system, which will be set out later, have been based on the results of back ray tracing wherein light rays passing through the entrance pupil E of the eyepiece optical system 5, defined by the position to be viewed by a viewer, travels toward the image display device 3 via the eyepiece optical system 5, as shown typically in FIG. 4.

Referring to the coordinate system used here, the origin O of a decentered optical surface of a decentered optical system is defined by a point O of intersection of the axis 2 of rotational symmetry of the eyepiece optical system 5 with the visual axis 101 that connects the entrance pupil E with the reflective optical device 51, as shown in FIG. 4. Then, the Y-axis positive direction is defined by a direction from the origin O of the axis 2 of rotational symmetry of the eyepiece optical system 5 toward the image display device 3 side, the Z-axis positive direction is defined by a right direction from the origin O (the direction of the visual axis 101), and the Y-Z plane is defined within the drawing sheet of FIG. 4. Then, the X-axis positive direction is defined by an axis that forms a right-handed orthogonal coordinate system with the Y- and Z-axes.

Given to each decentered surface are the amount of decentration of the apex of that surface from the center of the origin of the optical system (X, Y and Z in the X-, Y- and Z-axis directions) and the angles (α, β, γ, (°)) of tilt of the center axis of that surface with respect to the X-axis, the Y-axis, and the Z-axis of the coordinate system defined at the origin of the optical system, respectively. It is here noted that the positive α and β means clockwise rotation with respect to the positive directions of the respective axes, and the positive γ means clockwise rotation with respect to the positive direction of the Z-axis. Referring to the α, β, γ rotation of the center axis of a certain surface, the coordinate system that defines each surface is first a rotated counterclockwise about the X-axis of the coordinate system defined at the origin of the optical system. Then, the rotated surface is β rotated counterclockwise about the Y-axis of a new coordinate system. Then, the twice rotated surface is γ rotated clockwise about the Z-axis of a new coordinate system.

When a specific surface of the optical function surfaces forming the optical system of each example and the subsequent surface form together a coaxial optical system, there is a surface-to-surface spacing given. Besides, the radius of curvature of each surface, and the refractive indices and Abbe constants of the media are given as usual.

Coefficient terms, of which no data are given in the parameters set out later, are zero. The refractive index and Abbe constants of the media are given on a d-line (587.56 nm wavelength) basis, and the length is given in mm. The decentration of each surface is given in terms of the amount of decentration from the reference surface. The interpupillary distance of both eyes of the viewer is given in terms of X-decentration of the stop surface: it is indicated by a width of 60 mm in an optical path diagram in the horizontal section.

It is to be noted that the Fresnel surface comprises a rotationally symmetric surface obtained by rotation of a curve having an even-numbered degree and an odd-numbered degree about the axis of rotational symmetry that is parallel with and away from the Y-axis by RX: it is a rotationally symmetric aspheric surface obtained by rotation of a curve defined by the following defining formula.

Z=(Y²/RY)/[1+{1−(1+k)Y²/R²}^{1/2}]+AY³+BY⁴+CY⁵+DY⁶+ (a)

However, there is the axis of rotational symmetry parallel with the Y-axis, and RX is indicative of the radius of curvature in the rotational symmetry direction. In formula (a), RY is the paraxial radius of curvature, k is the conic constant, and A, B, C, C, . . . are the third-order, fourth-order, fifth-order, sixth-order aspheric coefficients, respectively.

The free-form surface used herein is defined by the following formula (b). Note here that the axis of the free-form surface is given by the Z-axis of that defining formula.

$$Z = ( {r}^{2} / R ) / [ 1 + \sqrt{ } \{ 1 - ( 1 + k ) {( r / R )}^{2} \} ] + {\sum }_{j = 1}^{66} {C}_{j} {X}^{m} {Y}^{n} \qquad ( b )$$

In formula (b) here, the first term is a spherical term and the second term is a free-form surface term.

In the spherical term,

R is the radius of curvature of the vertex,

k is the conic constant, and

r=√(X²+Y²).

The free-form surface term is

$${\sum }_{j = 1}^{66} {C}_{j} {X}^{m} {Y}^{n} = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{2} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7} …$$

Here Cⱼ (j is an integer of 1 or greater) is a coefficient.

In general, the aforesaid free-form surface has no plane of symmetry at both the X-Z plane and the Y-Z plane. However, by reducing all the odd-numbered degree terms for X down to zero, that free-form surface can have only one plane of symmetry parallel with the Y-Z plane. For instance, this may be achieved by reducing down to zero the coefficients for the terms C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . .

By reducing all the odd-numbered degree terms for Y down to zero, the free-form surface can have only one plane of symmetry parallel with the X-Z plane. For instance, this may be achieved by reducing down to zero the coefficients for the terms C₃, C₅, C_{g}, C₁₀, C₁₂, C₁₄, C₁₇, C₁₉, C₂₁, C₂₃, C₂₅, C₂₇, C₃₀, C₃₂, C₃₄, C₃₆, . . . .

If any one of the directions of the aforesaid plane of symmetry is used as the plane of symmetry and decentration is implemented in a direction corresponding to that, for instance, the direction of decentraton of the optical system with respect to the plane of symmetry parallel with the Y-Z plane is set in the Y-axis direction and the direction of dencentration of the optical system with respect to the plane of symmetry parallel with the X-Z plane is set in the X-axis direction, it is then possible to improve productivity while, at the same time, making effective correction of rotationally asymmetric aberrations occurring from decentration.

The aforesaid defining formula (b) is given for the sake of illustration alone: the feature of the invention is that by use of the rotationally asymmetric surface having only one plane of symmetry, it is possible to correct rotationally asymmetric aberrations occurring from decentration while, at the same time, improving productivity. It goes without saying that the same advantages are achievable even with any other defining formulae.

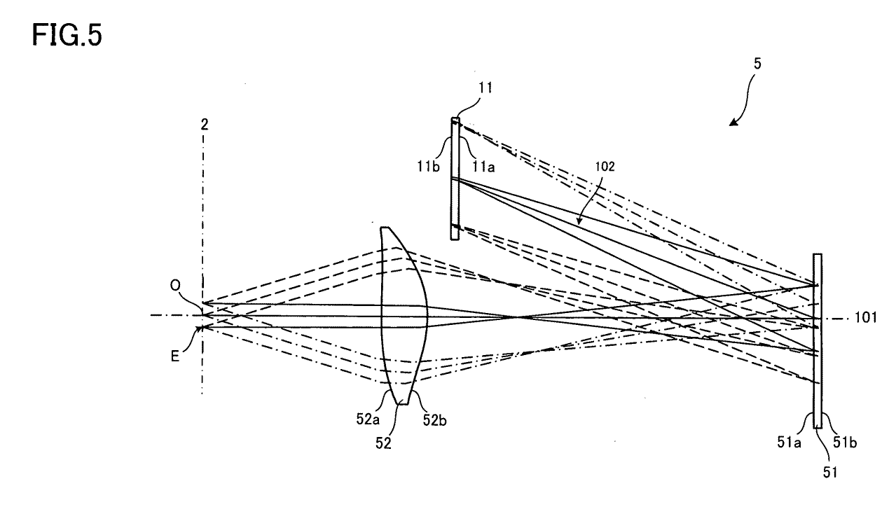

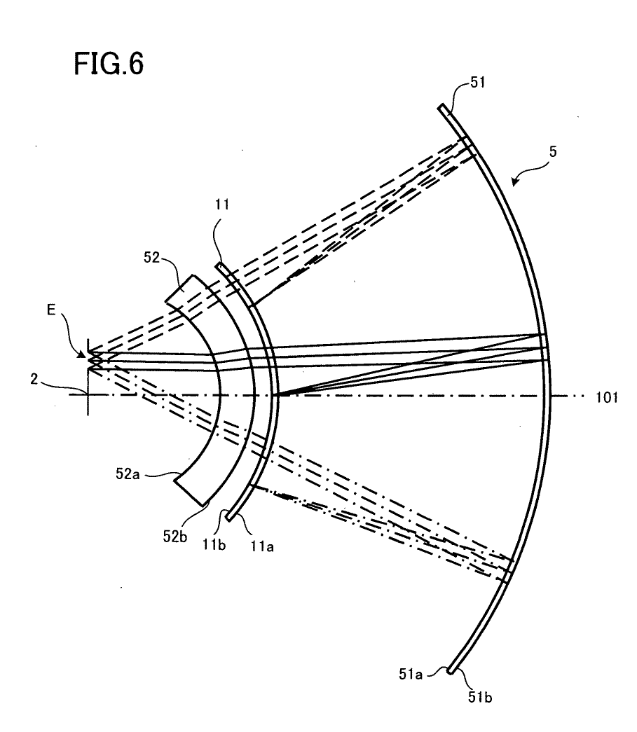

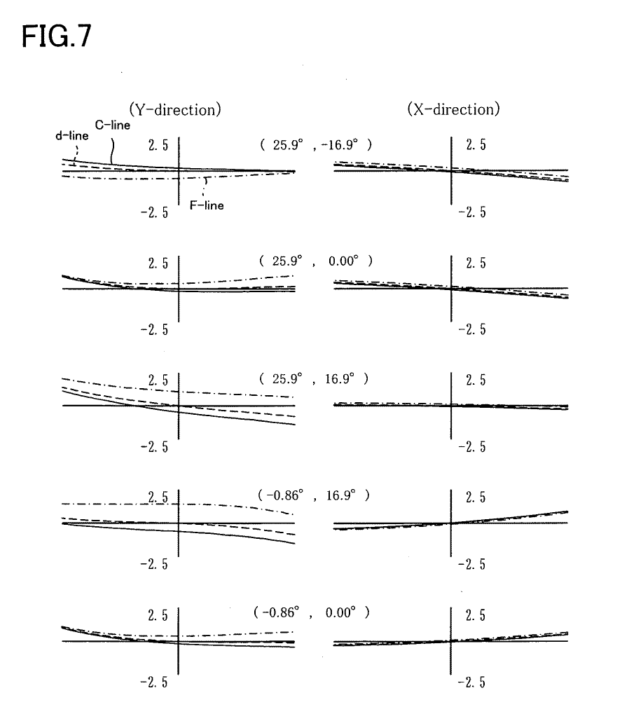

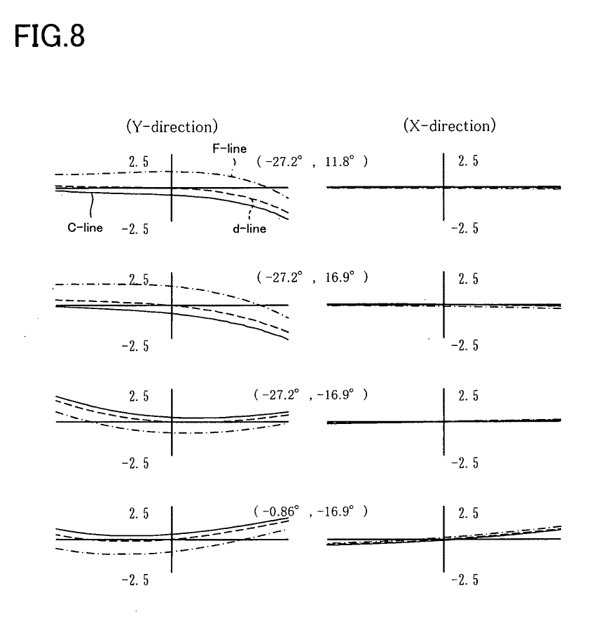

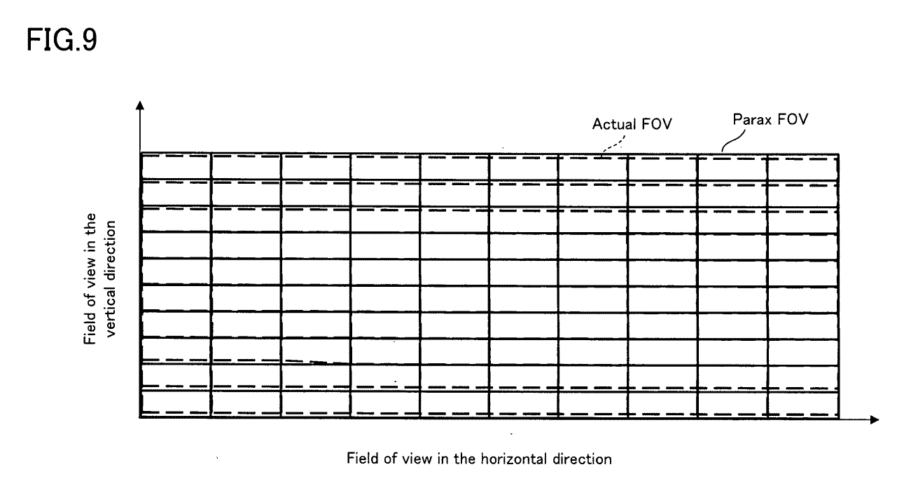

FIG. 5 is a sectional view of the eyepiece optical system 5 of the visual display apparatus 1 according to Example 1, as taken along the axis 2 of rotational symmetry. FIG. 6 is a plan view of FIG. 5. FIGS. 7 and 8 are transverse aberration diagrams for the whole optical system. FIG. 9 is illustrative of image distortion on the diffusing surface (image plane) in Example 1 upon back ray tracing while viewed by the left eye.

In Example 1 here, the eyepiece optical system 5 comprises the diffusing surface 11 adapted to diffuse an image projected through a projection optical system (not shown), the reflective optical device 51 having at least one reflecting surface adapted to reflect an image diffused through the diffusing surface 11, and at least one rotationally asymmetric transmissive optical device 52 adapted to transmit an image reflected by the reflective optical device 51, with the number of imaging (image formation) differing at a certain first section and at a second section orthogonal to the first section. Note here that an image display device and the projection optical system are not shown in FIGS. 5 and 6.

Referring more specifically to the eyepiece optical system 5, the rotationally asymmetric optical device 52 is made up of a first surface 52a and a second surface 52b, each defined by a free-form surface, the reflective optical device 51 is made up of a first surface 51a of cylindrical shape and a second surface 51b of Fresnel shape, and the diffusing surface 11 is made up of a first surface 11a and a second surface 11b, each defined by a cylindrical surface.

The reflective optical device 51, and the diffusing surface 11 is rotationally symmetric about the axis 2 of rotational symmetry. In the second section, the shape of the reflecting surface 51b of the reflective optical device 51 on one side with respect to the visual axis 101 is different from that on another side.

Upon back ray tracing, a light beam leaving the entrance pupil E of the eyepiece optical system 5 travels toward the reflective optical device 51 via the first and second surfaces 52a and 52b of the transmissive optical device 52. The light beam is imaged in the second section between the transmissive optical device 52 and the reflective optical device 51. In turn, the light beam transmits through the first surface 51a of the reflective optical device 51, is reflected at the second surface 51b, and again transmits through the first surface 51a, traveling toward the diffusing surface 11. Then, the light beam passes through the first and second surfaces 11a and 11b of the diffusing surface 11, and is imaged near the second surface 11b after transmitting through it. Thereafter, the light beam is imaged at the image display device via the projection optical system (not shown).

The specifications of Example 1 are:

Angle of view (in terms of aberrations): 53°, vertically 33°
Entrance pupil diameter (back ray tracing): 15.00
Image distortion rate (Y/X): −0.58787

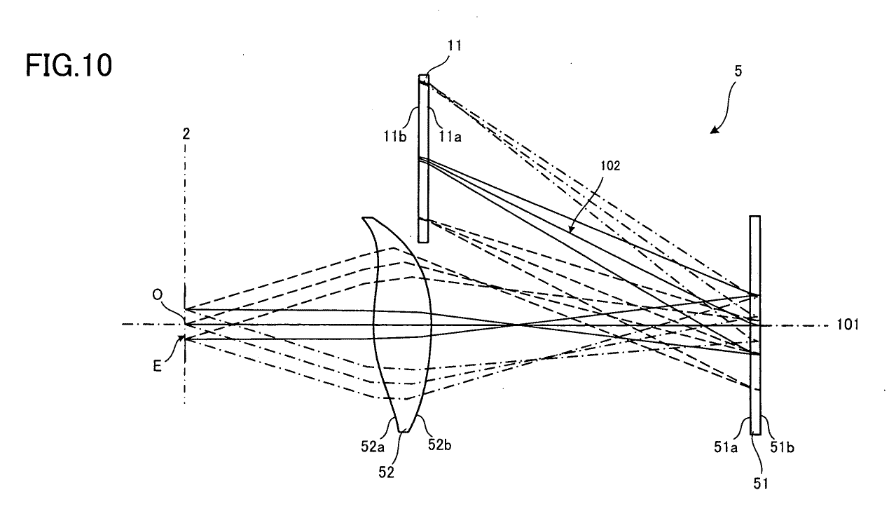

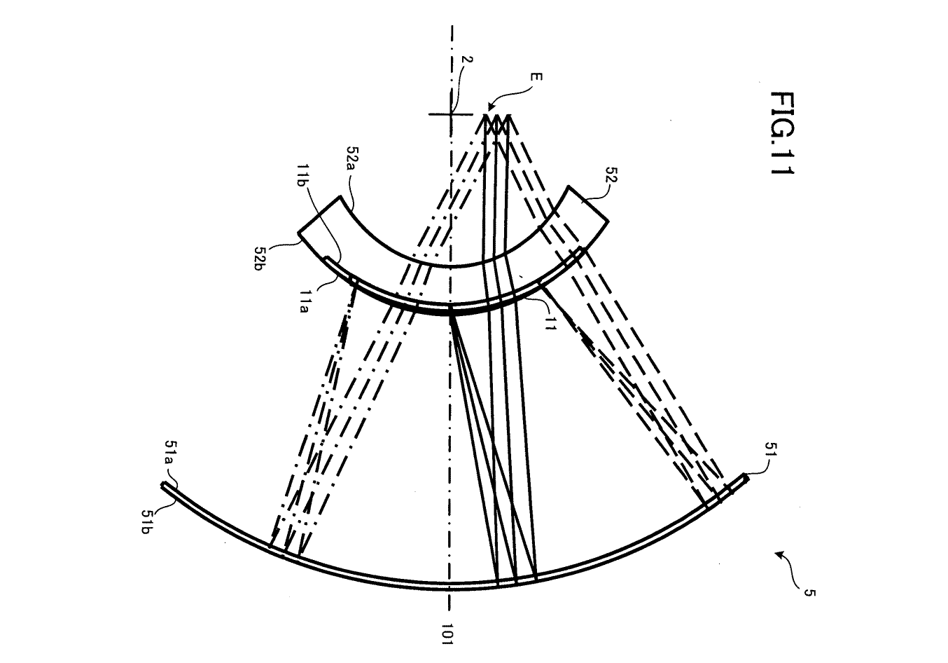

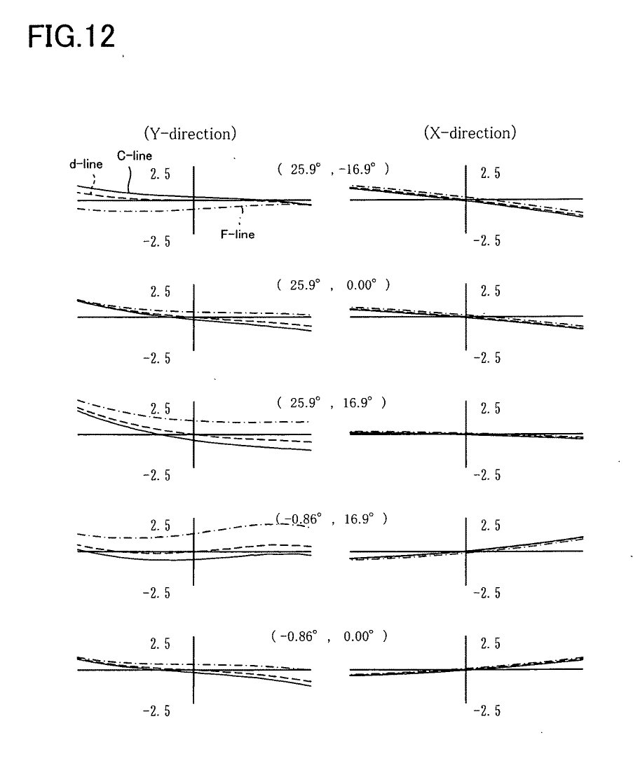

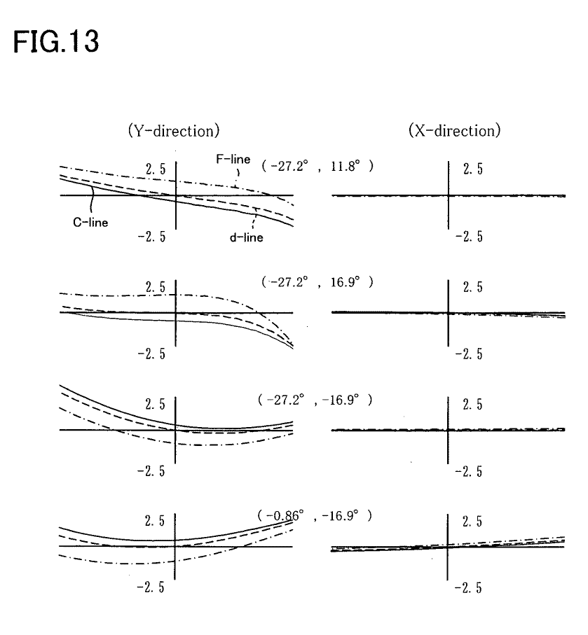

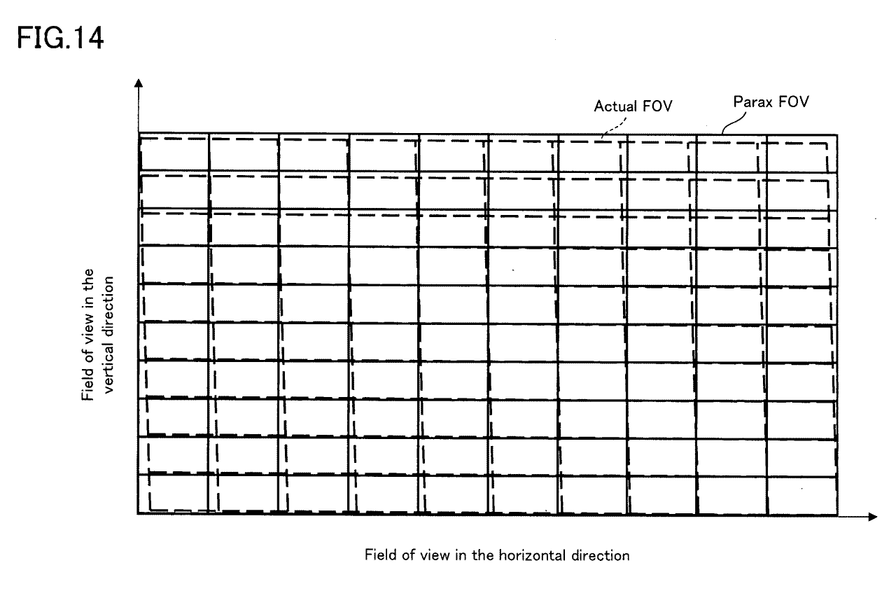

FIG. 10 is a sectional view of the eyepiece optical system 5 of the visual display apparatus 1 according to Example 2, as taken along the axis 2 of rotational symmetry. FIG. 11 is a plan view of FIG. 10. FIGS. 12 and 13 are transverse aberration diagrams for the whole optical system. FIG. 14 is illustrative of image distortion on the diffusing surface (image plane) in Example 2 upon back ray tracing while viewed by the left eye.

In Example 2 here, the eyepiece optical system 5 comprises the diffusing surface 11 adapted to diffuse an image projected through a projection optical system (not shown), the reflective optical device 51 having at least one reflecting surface adapted to reflect an image diffused through the diffusing surface 11, and at least one rotationally asymmetric transmissive optical device 52 adapted to transmit an image reflected by the reflective optical device 51, with the number of imaging (image formation) differing at a certain first section and at a second section orthogonal to the first section. Note here that an image display device and the projection optical system are not shown in FIGS. 10 and 11.

Referring more specifically to the eyepiece optical system 5, the rotationally asymmetric optical device 52 is made up of a first surface 52a and a second surface 52b, each defined by a free-form surface, the reflective optical device 51 is made up of a first surface 51a of cylindrical shape and a second surface 51b of Fresnel shape, and the diffusing surface 11 is made up of a first surface 11a and a second surface 11b, each defined by a cylindrical surface.

The reflective optical device 51, and the diffusing surface 11 is rotationally symmetric about the axis 2 of rotational symmetry. In the second section, the shape of the reflecting surface 51b of the reflective optical device 51 on one side with respect to the visual axis 101 is different from that on another side.

Upon back ray tracing, a light beam leaving the entrance pupil E of the eyepiece optical system 5 travels toward the reflective optical device 51 via the first and second surfaces 52a and 52b of the transmissive optical device 52. The light beam is imaged in the second section between the transmissive optical device 52 and the reflective optical device 51. In turn, the light beam transmits through the first surface 51a of the reflective optical device 51, is reflected at the second surface 51b, and again transmits through the first surface 51a, traveling toward the diffusing surface 11. Then, the light beam passes through the first and second surfaces 11a and 11b of the diffusing surface 11, and is imaged near the second surface 11b after transmitting through it. Thereafter, the light beam is imaged at the image display device via the projection optical system (not shown).

The specifications of Example 2 are:

Angle of view (in terms of aberrations): 53°, vertically 33°
Entrance pupil diameter (back ray tracing): 15.00
Image distortion rate (Y/X): −0.84427

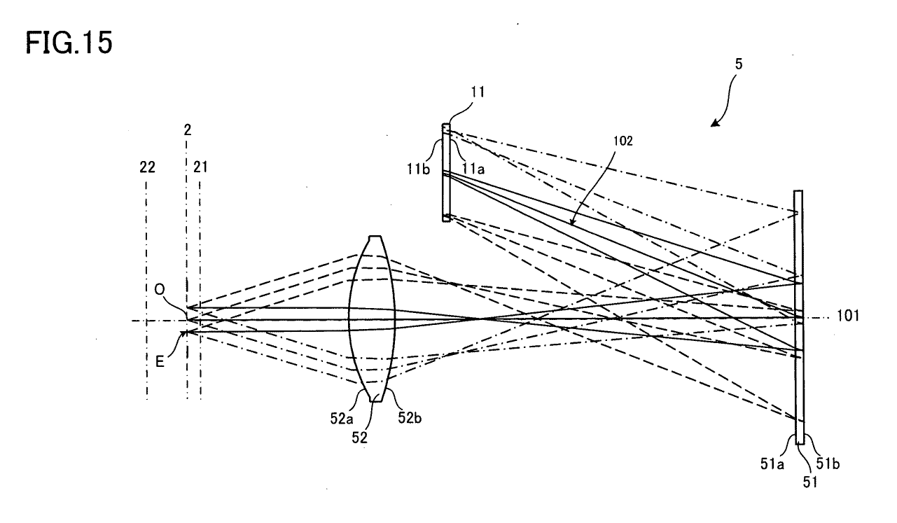

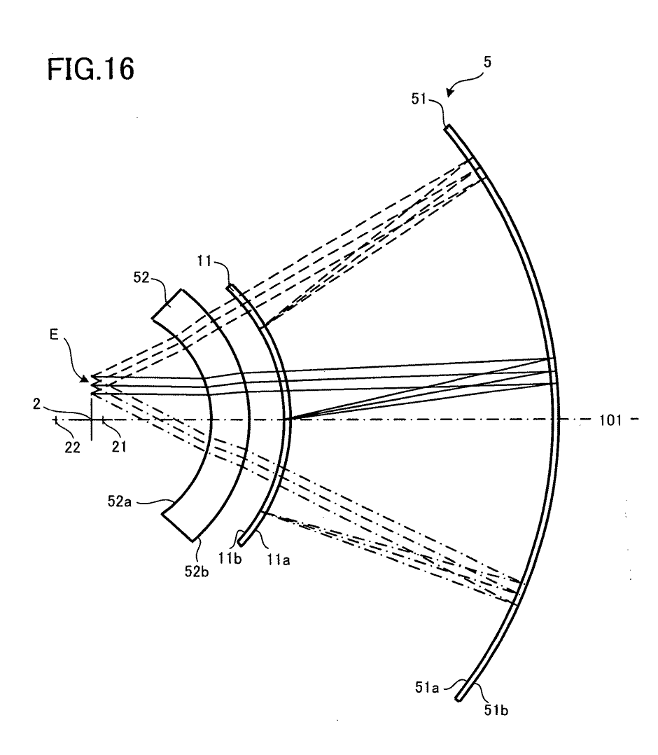

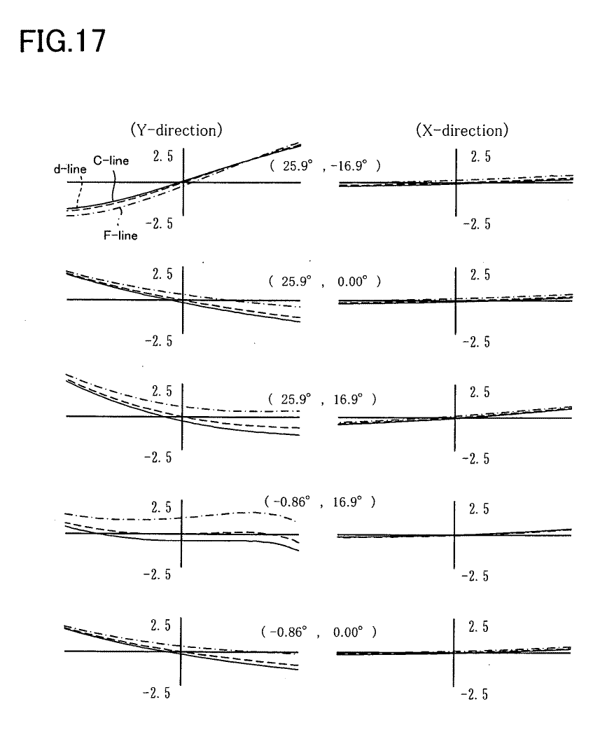

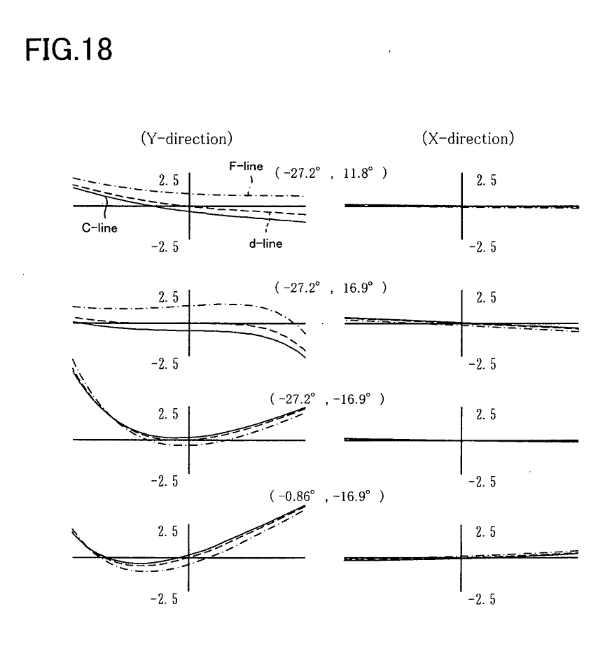

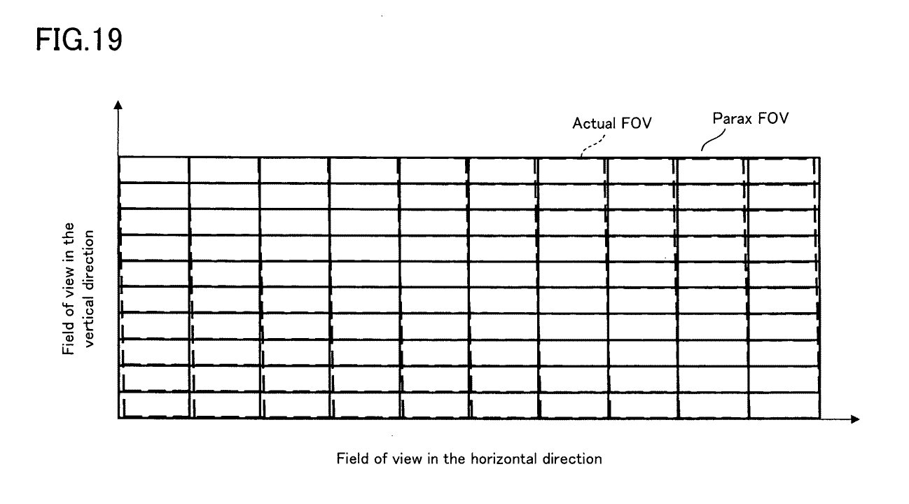

FIG. 15 is a sectional view of the eyepiece optical system 5 of the visual display apparatus 1 according to Example 32, as taken along the axis 2 of rotational symmetry. FIG. 16 is a plan view of FIG. 15. FIGS. 17 and 18 are transverse aberration diagrams for the whole optical system. FIG. 19 is illustrative of image distortion on the diffusing surface (image plane) in Example 3 upon back ray tracing while viewed by the left eye.

In Example 3 here, the eyepiece optical system 5 comprises the diffusing surface 11 adapted to diffuse an image projected through a projection optical system (not shown), the reflective optical device 51 having at least one reflecting surface adapted to reflect an image diffused through the diffusing surface 11, and at least one rotationally asymmetric transmissive optical device 52 adapted to transmit an image reflected by the reflective optical device 51, with the number of imaging (image formation) differing at a certain first section and at a second section orthogonal to the first section. Note here that an image display device and the projection optical system are not shown in FIGS. 15 and 16.

Referring more specifically to the eyepiece optical system 5, the rotationally asymmetric optical device 52 is made up of a first surface 52a and a second surface 52b, each defined by a Y-toroidal surface, the reflective optical device 51 is made up of a first surface 51a of cylindrical shape and a second surface 51b of Fresnel shape, and the diffusing surface 11 is made up of a first surface 11a and a second surface 11b, each defined by a cylindrical surface.

The first surface 52a of the transmissive optical device 52 is rotationally symmetric about the first axis 21 of planar and rotational symmetry, and the second surface 52b of the transmissive optical device 52 is rotationally symmetric about the second axis 22 of planar and rotational symmetry. The reflective optical device 51, and the diffusing surface 11 is rotationally symmetric about the axis 2 of rotational symmetry. In the second section, the shape of the reflecting surface 51b of the reflective optical device 51 on one side with respect to the visual axis 101 is different from that on another side.

Upon back ray tracing, a light beam leaving the entrance pupil E of the eyepiece optical system 5 travels toward the reflective optical device 51 via the first and second surfaces 52a and 52b of the transmissive optical device 52. The light beam is imaged in the second section between the transmissive optical device 52 and the reflective optical device 51. In turn, the light beam transmits through the first surface 51a of the reflective optical device 51, is reflected at the second surface 51b, and again transmits through the first surface 51a, traveling toward the diffusing surface 11. Then, the light beam passes through the first and second surfaces 11a and 11b of the diffusing surface 11, and is imaged near the second surface 11b after transmitting through it. Thereafter, the light beam is imaged at the image display device via the projection optical system (not shown).

The specifications of Example 3 are:

Angle of view (in terms of aberrations): 53°, vertically 33°
Entrance pupil diameter (back ray tracing): 15.00
Image distortion rate (Y/X): −0.57671

Set out below are the parameters constituting part of Examples 1, 2 and 3, wherein the abbreviation FFS is indicative of the free-form surface.

### Example 1

| | | | | | Abbe |
|---|---|---|---|---|---|
| Surface | Radius | | | Refractive | num- |
| number | of curvature | Plane gap | Eccentricity | index | ber |
| Object | ∞ | −2000.00 | | | |
| plane | | | | | |
| 1 | ∞ (Entrance | 0.00 | Eccentricity (1) | | |
| | pupil) | | | | |
| 2 | FFS [1] | 0.00 | Eccentricity (2) | 1.8348 | 42.7 |
| 3 | FFS [2] | 0.00 | Eccentricity (3) | | |
| 4 | Cylindrical [1] | 0.00 | Eccentricity (4) | 1.4918 | 57.4 |
| 5 | Fresnel [1] | 0.00 | Eccentricity (5) | 1.4918 | 57.4 |
| 6 | Cylindrical [1] | 0.00 | Eccentricity (4) | | |
| 7 | Cylindrical [2] | 0.00 | Eccentricity (6) | | |
| 8 | Cylindrical [3] | 0.00 | Eccentricity (7) | | |
| Image | Cylindrical [3] | | Eccentricity (7) | | |
| plane | | | | | |

Fresnel {1}

| | |
|---|---|
| RY | −392.56 |
| RX | −400.00 |
| A | 3.3730E−006 |
| B | 2.2010E−008 |

Cylindrical [1]

| | |
|---|---|
| RY | ∞ |
| RX | −395 |

Cylindrical [2]

| | |
|---|---|
| RY | ∞ |
| RX | −165.53 |

Cylindrical [3]

| | |
|---|---|
| RY | ∞ |
| RX | −160.53 |

FFS [1]

| | | | | | |
|---|---|---|---|---|---|
| C4 | −5.7250E−003 | C6 | 1.6363E−003 | C10 | −3.1919E−005 |
| C11 | −2.1094E−007 | C13 | −3.8071E−007 | C15 | −3.4790E−008 |

FFS [2]

| | | | | | |
|---|---|---|---|---|---|
| C4 | −4.1105E−003 | C6 | −7.3143E−003 | C10 | −3.7233E−005 |
| C11 | −6.2007E−008 | C13 | −6.0594E−007 | C15 | 3.8807E−007 |

Decentration [1]

| | | | | | |
|---|---|---|---|---|---|
| X | 30.00 | Y | 0.00 | Z | 0.00 |
| α | 0.00 | β | 0.00 | γ | 0.00 |

Decentration [2]

| | | | | | |
|---|---|---|---|---|---|
| X | 0.00 | Y | 0.00 | Z | 115.51 |
| α | 0.00 | β | 0.00 | γ | 0.00 |

Decentration [3]

| | | | | | |
|---|---|---|---|---|---|
| X | 0.00 | Y | 0.00 | Z | 145.51 |
| α | 0.00 | β | 0.00 | γ | 0.00 |

Decentration [4]

| | | | | | |
|---|---|---|---|---|---|
| X | 0.00 | Y | 0.00 | Z | 395.00 |
| α | 0.00 | β | 0.00 | γ | 0.00 |

Decentration [5]

| | | | | | |
|---|---|---|---|---|---|
| X | 0.00 | Y | 41.24 | Z | 400.00 |
| α | 0.00 | β | 0.00 | γ | 0.00 |

Decentration [6]

| | | | | | |
|---|---|---|---|---|---|
| X | 0.00 | Y | 86.70 | Z | 165.53 |
| α | 0.00 | β | 0.00 | γ | 0.00 |

Decentration [7]

| | | | | | |
|---|---|---|---|---|---|
| X | 0.00 | Y | 86.70 | Z | 160.53 |
| α | 0.00 | β | 0.00 | γ | 0.00 |

Decentration [3]

### Example 2

| | | | | Re- | Abbe |
|---|---|---|---|---|---|
| Surface | Radius | | | fractive | num- |
| number | of curvature | Plane gap | Eccentricity | index | ber |
| Object | ∞ | −2000.00 | | | |
| plane | | | | | |
| 1 | ∞ (Entrance | 0.00 | Eccentricity (1) | | |
| | pupil) | | | | |
| 2 | FFS [1] | 0.00 | Decentration (2) | 1.8348 | 42.7 |
| 3 | FFS [2] | 0.00 | Decentration (3) | | |
| 4 | Cylindrical [1] | 0.00 | Decentration (4) | 1.4918 | 57.4 |
| 5 | Fresnel [1] | 0.00 | Decentration (5) | 1.4918 | 57.4 |
| 6 | Cylindrical [1] | 0.00 | Decentration (4) | | |
| 7 | Cylindrical [2] | 0.00 | Decentration (6) | | |
| 8 | Cylindrical [3] | 0.00 | Decentration (7) | | |
| Image | Cylindrical [3] | 0.00 | Decentration (7) | | |
| plane | | | | | |

Fresnel [1]

| | |
|---|---|
| RY | −319.84 |
| RX | −300 |
| A | 9.6031E−006 |
| B | 6.6694E−008 |

Cylindrical [1]

| | |
|---|---|
| RY | ∞ |
| RX | −295 |

Cylindrical [2]

| | |
|---|---|
| RY | ∞ |
| RX | −125.09 |

Cylindrical [3]

| | |
|---|---|
| RY | ∞ |
| RX | −120.09 |

FFS [1]

| | | | | | |
|---|---|---|---|---|---|
| C4 | −6.6608E−003 | C6 | 6.0470E−003 | C10 | −6.1168E−005 |
| C11 | −4.0967E−007 | C13 | −1.5489E−006 | C15 | −1.6580E−006 |

FFS [2]

| | | | | | |
|---|---|---|---|---|---|
| C4 | −4.6162E−003 | C6 | −4.5047E−003 | C10 | −5.9683E−005 |
| C11 | −1.0357E−007 | C13 | −1.5348E−006 | C15 | −9.6975E−007 |

Decentration [1]

| | | | | | |
|---|---|---|---|---|---|
| X | 30.00 | Y | 0.00 | Z | 0.00 |
| α | 0.00 | β | 0.00 | γ | 0.00 |

Decentration [2]

| | | | | | |
|---|---|---|---|---|---|
| X | 0.00 | Y | 0.00 | Z | 96.86 |
| α | 0.00 | β | 0.00 | γ | 0.00 |

Decentration [3]

| | | | | | |
|---|---|---|---|---|---|
| X | −30.00 | Y | 0.00 | Z | 126.86 |
| α | 0.00 | β | 0.00 | γ | 0.00 |

Decentration [4]

| | | | | | |
|---|---|---|---|---|---|
| X | −30.00 | Y | 0.00 | Z | 295.00 |
| α | 0.00 | β | 0.00 | γ | 0.00 |

Decentration [5]

| | | | | | |
|---|---|---|---|---|---|
| X | 0.00 | Y | 41.24 | Z | 300.00 |
| α | 0.00 | β | 0.00 | γ | 0.00 |

Decentration [6]

| | | | | | |
|---|---|---|---|---|---|
| X | 0.00 | Y | 86.70 | Z | 125.09 |
| α | 0.00 | β | 0.00 | γ | 0.00 |

Decentration [7]

| | | | | | |
|---|---|---|---|---|---|
| X | 0.00 | Y | 86.70 | Z | 120.09 |
| α | 0.00 | β | 0.00 | γ | 0.00 |

Decentration [2]

### Example 3

| | | | | Re- | Abbe |
|---|---|---|---|---|---|
| Surface | Radius | | | fractive | num- |
| number | of curvature | Plane gap | Eccentricity | index | ber |
| Object | ∞ | −2000.00 | | | |
| plane | | | | | |
| 1 | ∞ (Entrance | 0.00 | Eccentricity (1) | | |
| | pupil) | | | | |
| 2 | Y-toroidal [1] | 0.00 | Decentration (2) | 1.8348 | 42.7 |
| 3 | Y-toroidal [2] | 0.00 | Decentration (3) | | |
| 4 | Cylindrical [1] | 0.00 | Decentration (4) | | |
| 5 | Fresnel [1] | 0.00 | Decentration (5) | 1.4918 | 57.4 |
| 6 | Cylindrical [1] | 0.00 | Decentration (4) | 1.4918 | 57.4 |
| 7 | Cylindrical [2] | 0.00 | Decentration (6) | | |
| 8 | Cylindrical [3] | 0.00 | Decentration (7) | | |
| Image | Cylindrical [3] | | | | |
| plane | | | | | |

Fresnel [1]

| | |
|---|---|
| RY | −395.33 |
| RX | −400.00 |
| A | 1.9197E−006 |
| B | 1.2391E−008 |

Cylindrical [1]

| | |
|---|---|
| RY | ∞ |
| RX | −395 |

Cylindrical [2]

| | |
|---|---|
| RY | ∞ |
| RX | −170.07 |

Cylindrical [3]

| | |
|---|---|
| RY | ∞ |
| RX | −165.07 |

Y-toroidal [1]

| | |
|---|---|
| RY | 96.66 |
| RX | −99.43 |

Y-toroidal [2]

| | |
|---|---|
| RY | −152.33 |
| RX | −139.67 |

Decentration [1]

| | | | | | |
|---|---|---|---|---|---|
| X | 30.00 | Y | 0.00 | Z | 0.00 |
| α | 0.00 | β | 0.00 | γ | 0.00 |

Decentration [2]

| | | | | | |
|---|---|---|---|---|---|
| X | 0.00 | Y | 0.00 | Z | 103.98 |
| α | 0.00 | β | 0.00 | γ | 0.00 |

Decentration [3]

| | | | | | |
|---|---|---|---|---|---|
| X | 0.00 | Y | 0.00 | Z | 133.981 |
| α | 0.00 | β | 0.00 | γ | 0.00 |

Decentration [4]

| | | | | | |
|---|---|---|---|---|---|
| X | 0.00 | Y | 0.00 | Z | 395.00 |
| α | 0.00 | β | 0.00 | γ | 0.00 |

Decentration [5]

| | | | | | |
|---|---|---|---|---|---|
| X | 0.00 | Y | 46.29 | Z | 400.00 |
| α | 0.00 | β | 0.00 | γ | 0.00 |

Decentration [6]

| | | | | | |
|---|---|---|---|---|---|
| X | 0.00 | Y | 92.06 | Z | 170.07 |
| α | 0.00 | β | 0.00 | γ | 0.00 |

Decentration [7]

| | | | | | |
|---|---|---|---|---|---|
| X | 0.00 | Y | 92.06 | Z | 165.07 |
| α | 0.00 | β | 0.00 | γ | 0.00 |

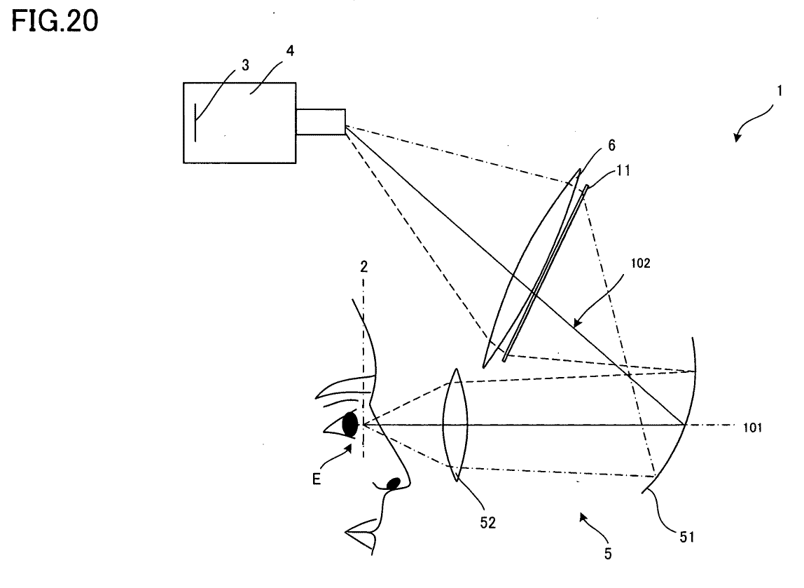

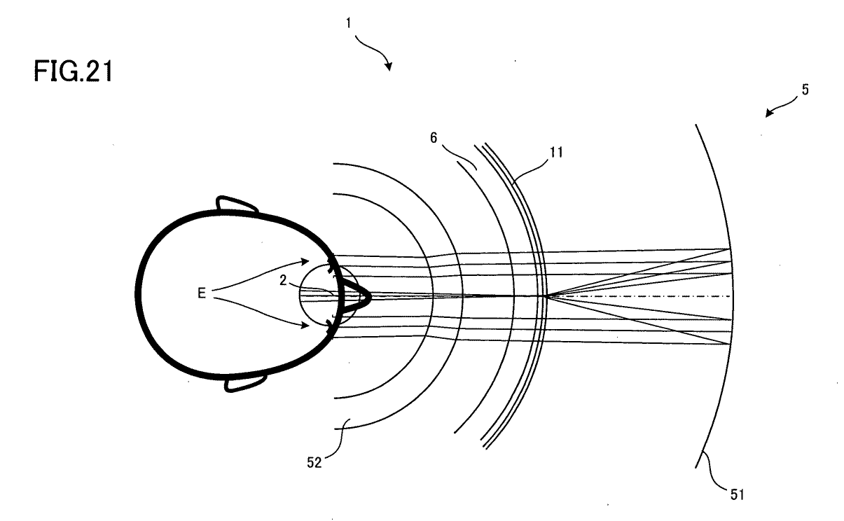

While some embodiments have been explained, it is to be understood that a pupil relay optical system 6 is preferably located near a projected image in such a way as to bring the exit pupil of the projection optical system in alignment with the entrance pupil E of the eyepiece optical system, as shown in FIGS. 20 and 21.

It is more preferable that two projection optical systems are provided in association with the left and right eyeballs. If images projected through the two projection optical systems are projected onto the diffusing surface and, at the same time, the angle of diffusion of the diffusing surface is controlled to get around crosstalks of the two images, it is then possible to view a three-dimensional image. If the diffusing surface is configured as a holographic one, it is then possible to avoid a problem that the diffusing surface itself comes in sight. The aforesaid problem may also be solved by rotating or vibrating the diffusing surface.

Furthermore, if the eyepiece optical system 5 is configured as a semi-transmissive surface, it is then possible to achieve a so-called combiner where outside images and electronic images are displayed in an overlapping fashion. Preferably in that case, a holographic device is applied to an annular substrate to allow the combiner to act also as a concave mirror.

Although the virtual image plane (object plane upon ray tracing) is assumed to lie 2 m away, it is to be understood that this is optional. When the surface to be viewed is at a finite distance, it will take on a cylindrical shape rotationally symmetric about the axis 2 of rotational symmetry, too.

What is claimed is:

1. A visual display apparatus comprising:
an image display device,
a projection optical system to project an image on said image display device, and
an eyepiece optical system to enable an image projected through said projection optical system to be viewed as a faraway virtual image, wherein said eyepiece optical system includes:
a diffusing surface to diffuse an image projected through said projection optical system,
a reflective optical device having at least one reflecting surface to reflect an image diffused through said diffusing surface, and
at least one rotationally asymmetric transmissive optical device to transmit an image reflected by said reflective optical device,
with the number of imaging differing at a certain first section and at a second section orthogonal to said first section.

2. The visual display apparatus according to claim 1, wherein said number of imaging is 0 at said first section and one at said second section.

3. The visual display apparatus according to claim 1, wherein said reflective optical device, and said transmissive optical device has a refractive index higher at said second section than at said first section.

4. The visual display apparatus according to claim 1, wherein said reflective optical device is rotationally symmetric about an axis of rotational symmetry.

5. The visual display apparatus according to claim 4, wherein said second section includes said axis of rotational symmetry.

6. The visual display apparatus according to claim 5, wherein said eyepiece optical system has a visual axis including a center chief ray traveling from a center of an entrance pupil toward said reflective optical device via said transmissive optical device upon back ray tracing in said second section, and said reflective optical device is decentered with respect to said visual axis in said second section.

7. The visual display apparatus according to claim 4, wherein said visual axis and said axis of rotational symmetry are orthogonal to each other.

8. The visual display apparatus according to claim 4, wherein said diffusing surface is rotationally symmetric about said axis of rotational symmetry.

9. The visual display apparatus according to claim 1, wherein said reflective optical device has a cylindrical form of linear Fresnel reflecting surface.

10. The visual display apparatus according to claim 1, wherein the shape of said reflective optical device on one side with respect to said visual axis is different from that on another side in said second section.

11. The visual display apparatus according to claim 1, wherein the shape of said transmissive optical device on one side with respect to said visual axis is different from that on another side in said second section.

12. The visual display apparatus according to claim 1, wherein said transmissive optical device comprises:
a first Y-toroidal surface having a first axis of planar and rotational symmetry, which is the center of rotation, in a surface of said reflective optical device including said axis of rotational symmetry, and
a second Y-toroidal surface having a second axis of planar and rotational symmetry, which is different from said first axis of planar and rotational symmetry.

13. The visual display apparatus according to claim 1, wherein said transmissive optical device comprises a free-form surface.
device including said axis of rotational symmetry, and
a second Y-toroidal surface having a second axis of planar and rotational symmetry, which is different from said first axis of planar and rotational symmetry.

14. The visual display apparatus according to claim 1, characterized in that said transmissive optical device comprises a free-form surface.
